(19) United States
(12) Patent Application Publication
(10) Pub. No.: US 2026/0017579 A1
(43) Pub. Date: Jan. 15, 2026

(54) SYSTEM FOR INFORMATION SHARING AND SITUATIONAL AWARENESS

(71) Applicants: Jenna Marie Ward, Brooklyn, NY (US); Anthony Steven Reedy, Baltimore, MD (US)

(72) Inventors: Jenna Marie Ward, Brooklyn, NY (US); Anthony Steven Reedy, Baltimore, MD (US)

(21) Appl. No.: 19/061,411

(22) Filed: Feb. 24, 2025

Related U.S. Application Data
(60) Provisional application No. 63/670,207, filed on Jul. 12, 2024.

(51) Int. Cl. G06Q 10/0631

(52) U.S. Cl. CPC G06Q 10/063114

(57) ABSTRACT

A system and computer-implemented method for information sharing and situational awareness are provided. The computer-implemented method of the present invention allows a user to specify one or more tasks to be monitored and completed in the system. The user can input one or more data items for one or more tasks and to input one or more users responsible for the one or more data items. The one or more users can perform one or more actions for the one or more data items which can be monitored, tracked, or analyzed for the user. One or more summaries can be automatically provided for the one or more tasks which can include one or more data analysis.

### CROSS-REFERENCE TO RELATED APPLICATIONS

This application claims the benefit of priority of U.S. provisional application No. 63/670,207, filed Jul. 12, 2024, the contents of which are herein incorporated by reference.

### BACKGROUND OF THE INVENTION

### Field of Endeavor

The present invention relates to informational analytics tools, and more particularly, to a system and method for information sharing configured to facilitate information collection, dissemination, and visualization of both qualitative and quantitative data.

### Background of Related Art

Business intelligence is utilized to inform business decisions and consists of collection and analysis of data from an organization. The most valuable business intelligence information combines both qualitative and quantitative information. Currently, business intelligence comes from a variety of sources, and formats such as e-mail, forms, productivity messaging tools, in-person meetings, etc. Current systems for management, and analysis of business intelligence information such as Domo and Tableau allow organization to build dashboards to monitor key performance indicators (KPIs), i.e. quantitative information, but provide no insight on the cause of trends in KPIs, i.e. qualitative information. These systems do not provide a unified tool to marshal information from a variety of sources.

Furthermore, business intelligence information can benefit from diverse qualitative information generated by many-to-many interactions amongst organizational employees. Current systems for peer interactions such as Jira allow task management and information sharing amongst peers, but this is a 1-to-1 request system, which is ineffective in marshalling many-to-many qualitative information. Additional solutions include the use of spreadsheet technologies to attempt to aggregate information, but spreadsheets have a number of deficiencies including ease of accidental data destruction via overwrites, wherein a user overwrites entries accidentally. Additionally, spreadsheets fail to facilitate easy consumption of information items as users typically must scroll across multiple columns to access both quantitative and qualitative information, which hinders quick analysis and decision-making. Finally, spreadsheets introduce data integrity issues associated with duplication and sharing of the underlying master document.

As can be seen, there is a need for a system for information sharing and situational awareness configured to marshal and visualize both quantitative and qualitative information into meaningful an impactful visualizations from a variety of disparate sources in a way superior to traditional productivity tools.

### SUMMARY OF THE INVENTION

Aspects of the present invention include a system and method for information sharing and situational awareness. In embodiments of the present invention the system and method receive one or more tasks for processing, analysis, and/or augmentation by one or more responsible users. The one or more tasks can include one or more metrics and/or one or more qualitative inputs associated with the one or more tasks or one or more metrics. The progress of the one or more responsible users processing, analyzing, and/or augmenting the one or more tasks is tracked and can include visual indicators of progress, alerts, and/or reminders. In aspects of the invention analysis of the at least one task, to include analysis of the one or more metrics, and/or the one or more qualitative inputs can be performed to generate at least one dataset. The at least one dataset can be transformed into at least one report such as a report, a graph, or a sentiment cloud, which can be output to a user interface for providing situational awareness to one or more users.

### BRIEF DESCRIPTION OF THE DRAWINGS

FIG. 1 is a flow diagram of an information sharing and situational awareness process, according to aspects of the present invention;

FIG. 2 is a flow diagram of a first sub-process of the information sharing and situational awareness process, according to aspects of the present invention;

FIG. 3 is a flow diagram of a second sub-process of the information sharing and situational awareness process, according to aspects of the present invention;

FIG. 4 is a diagram of a Dashboard User Interface according to aspects of the present invention;

FIG. 5 is a diagram of a New Request User Interface according to aspects of the present invention;

FIG. 6 is a first diagram of a Request Details User Interface according to aspects of the present invention; and

FIG. 7 is a second diagram of the Request Details User Interface, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a system, or centralized platform, for large-scale task management or information collection across an organization. The system of the present invention enables a user to easily create one or more tasks, distribute one or more tasks to additional users, send one or more reminder notifications to complete one or more tasks, and/or analyze team input in a succinct manner. The system of the present invention can implement one or more computerized methods to assist in task management.

Broadly, an embodiment of a system present invention may include one or more servers and at least one computer. Each server and computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

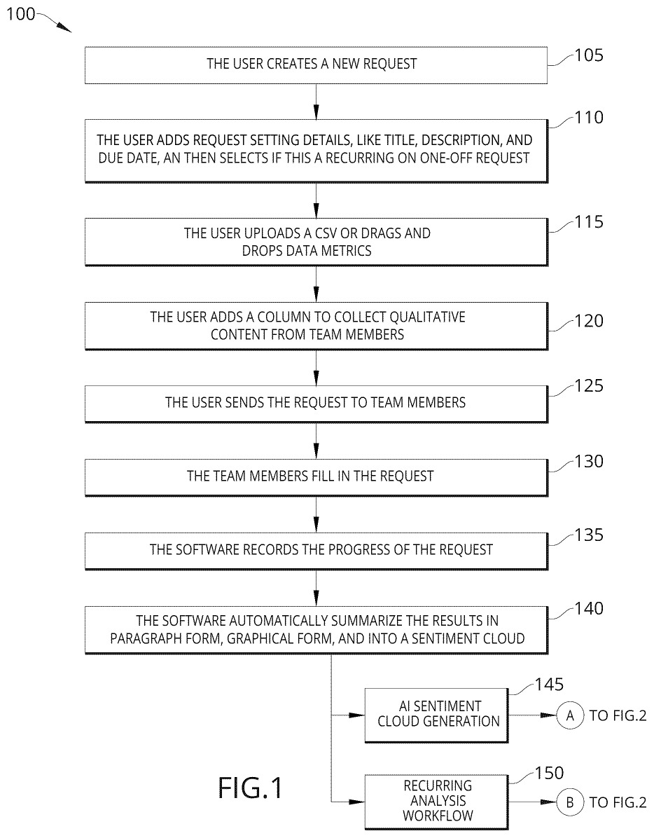

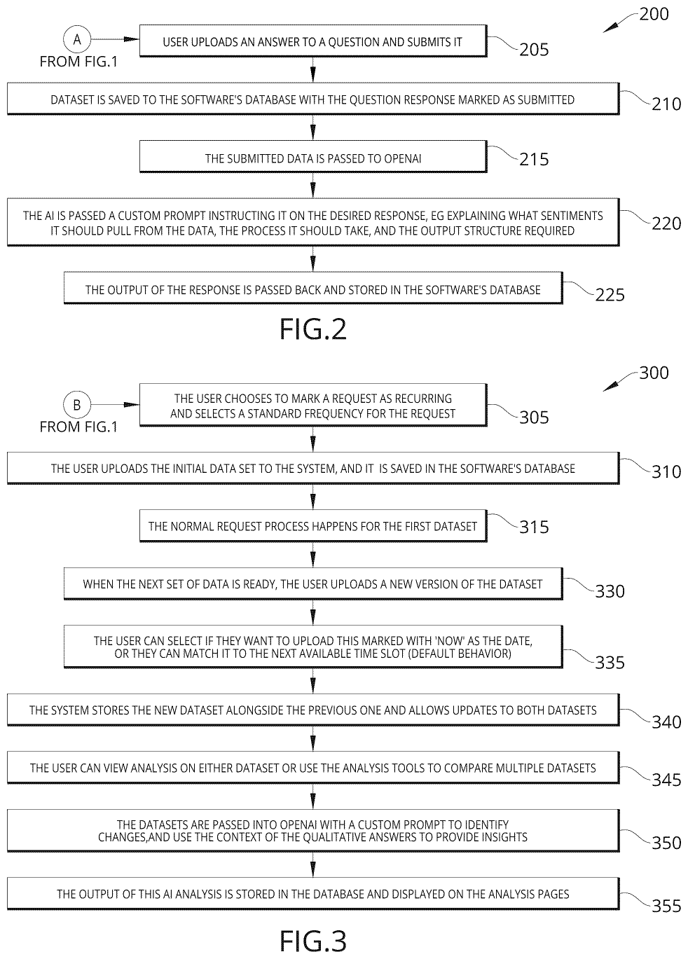

Referring now to FIGS. 1-7, the Figures illustrate aspects of the present invention as one or more computing device implemented systems, and one or more computing device implemented methods.

FIG. 1 illustrates an overall process for information sharing and situational awareness as a method 100. In embodiments, Method 100 can be a computer implemented method executed by the system of the present invention, outlined above. In embodiments, method 100 can begin as step 105 where a user can create at least one new request. In embodiments, the at least one new request can be a request for one or more items of data, tasks, analyses, business intelligence, etc., which can be one-off, or reoccurring, and/or customized based on one or more additional users, the user wishes to gather the one or more items from.

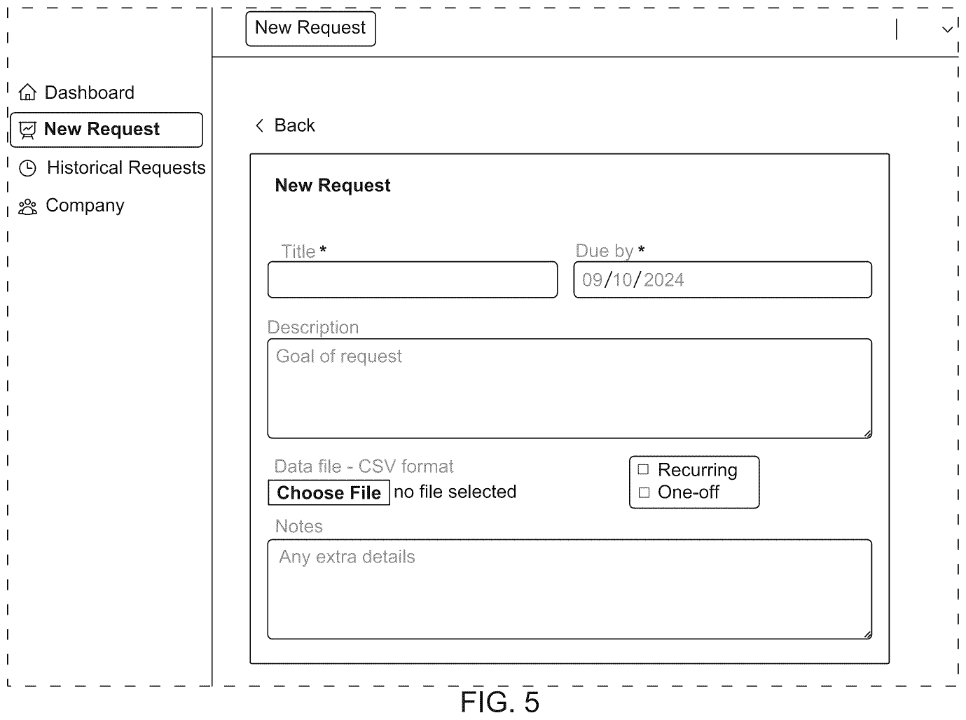

At step 110, the user can add one or more details to the at least one new request. In embodiments, the one or more details can include at least one metadata associated with the new request, such as, but not limited to, a title, a description of the request, one or more notes and/or one or more due dates (as illustrated in FIG. 5). Additionally, the one or more details can include at least one additional data item to the new request. In embodiments, the at least one additional data item can include, but is not limited to, an indicator that the new request is a one-off request (e.g. singular request) or a re-occurring request (step 150) (e.g. occurs at an interval) (as illustrated in FIG. 5). If the request is a re-occurring request, the user can specify, as an additional item, a frequency, time-period, or other temporal information for scheduling recurrence of the new request, further described as FIG. 3. In embodiments, the at least one new task can be a shared task needing a plurality of users to contribute to. As such, the user can specify, as one or the at least one additional data items, one or more users that are to participate in the new task. In embodiment, one or more Application Programming Interfaces (API) can connect to companies' HR systems, like Workday®, to choose groups of people like “your direct reports” or “everyone titled account manager”. In embodiments, any user who creates, sends, or receives a request can have an account with one or more account information. In embodiments, the one or more account information can include a name, and at least one contact information, such as an email address.

At step 115, one or more files and/or one or more metrics can be added to the new request using one or more interface elements (as illustrated in FIG. 5). In embodiments, the one or more files can include one or more quantitative inputs in a standardized format for ease of processing. In embodiments, the standardized format of the one or more quantitative inputs can be comma separated values (CSV), but is not so limited, as any format known in the art can be utilized. In embodiments, the one or more quantitative inputs can be utilized to generate one or more reports associated with the new task. Additionally, or alternatively, the user can add one or more metrics, using a report generator of the system to generate or supplement the one or more reports associated with the new task. In embodiments, the one or more metrics can be added via a user interface element, such as, but not limited to, a graphical user interface (GUI) with drag-and-drop functionality, wherein each of the one or more metrics is a draggable and droppable user interface element. In embodiments, the one or more metrics and/or quantitative inputs can include, but are not limited to, business Key Performance Indicators (KPI) commonly known in the art such as revenue, margin, performance data, spend, cash flow, customer lifetime value, customer acquisition cost, product quantity. Generally, the one or more metrics and/or qualitative inputs can be any data item that a company sets as a goal and needs to collect context to better understand. For example, in advertising the one or more metrics and/or qualitative inputs can additionally be advertiser product spend, advertiser performance, advertiser CPM.

At step 120, one or more qualitative inputs can be added to the new request using one or more interface elements. In embodiments, the one or more qualitative inputs can be input by the user as information the user needs to collect along with the one or more metrics and/or the one or more quantitative inputs. Additionally, the one or more qualitative inputs can include questions that the user needs addressed, or answered, and/or steps the user needs accomplished with for the new task.

At step 125, once all information is uploaded from the user for the new task, as outlined in steps 105-120, the user can submit the new task to be filled out by one or more responsible users. Additionally, the system can automatically generate one or more requests based on the one or more metrics, one or more quantitative input, and/or one or more qualitative inputs, and send one or more notifications to one or more users responsible for the one or more requests, which can include one or more action items.

In embodiments, for each of the one or more requests, one or more users can be specified as being responsible for completion of the request, which can include entering a username, name, and/or contact information, such as an e-mail address, of the one or more responsible users. Once the one or more requests are generated, a notification, such as an email, can be sent to the one or more responsible users providing notification of the one or more requests, and/or instructions to access the one or more requests, such as a hyperlink to access the one or more requests.

At step 130, one or more users responsible for the one or more requests can act on the one or more requests performing one or more actions, such as responding to the one or more requests, performing one or more actions items, etc. In embodiments, the one or more responsible users can view, edit, modify, and/or otherwise interact with only the one or more requests for which they have responsibility. In embodiments, one or more Artificial Intelligence (AI) systems can review and provide feedback on the one or more actions performed on the one or more requests by the one or more responsible users. In an exemplary embodiment, the one or more AI systems can review one of more answers submitted for accuracy and/or feedback on the quality of the one or more actions. In embodiments, once the one or more responsible users submit their one or more actions for the one or more requests the user can view the one or more actions via a user interface.

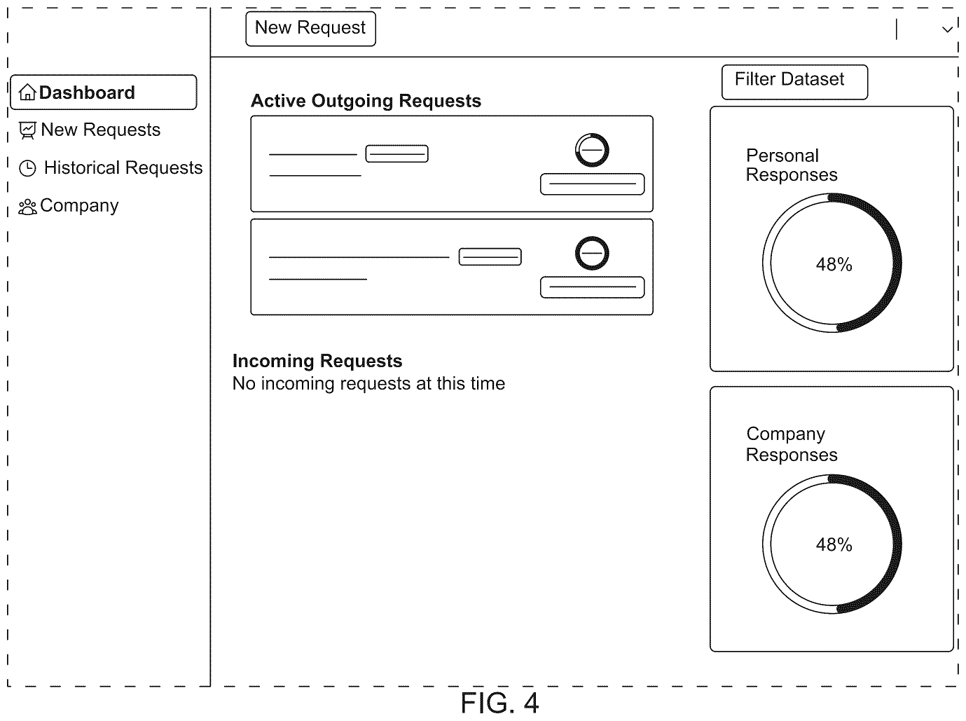

At step 135, which can occur substantially in parallel with step 130, progress of the new task is tracked by the system. In embodiments, the system visually illustrates the progress of the new task (as illustrated in FIG. 4), using one or more graphical elements, showing an amount of the new task completed, e.g. a percent completion. In an exemplary embodiment, as one or more responsible users performs one or more actions the progress of the new task is updated, in real-time, or near real-time. Additionally, one or more notifications can be sent to the one or more users responsible for the one or more requests. In embodiments, the one or more notifications can include due date reminders for the one or more requests, etc.

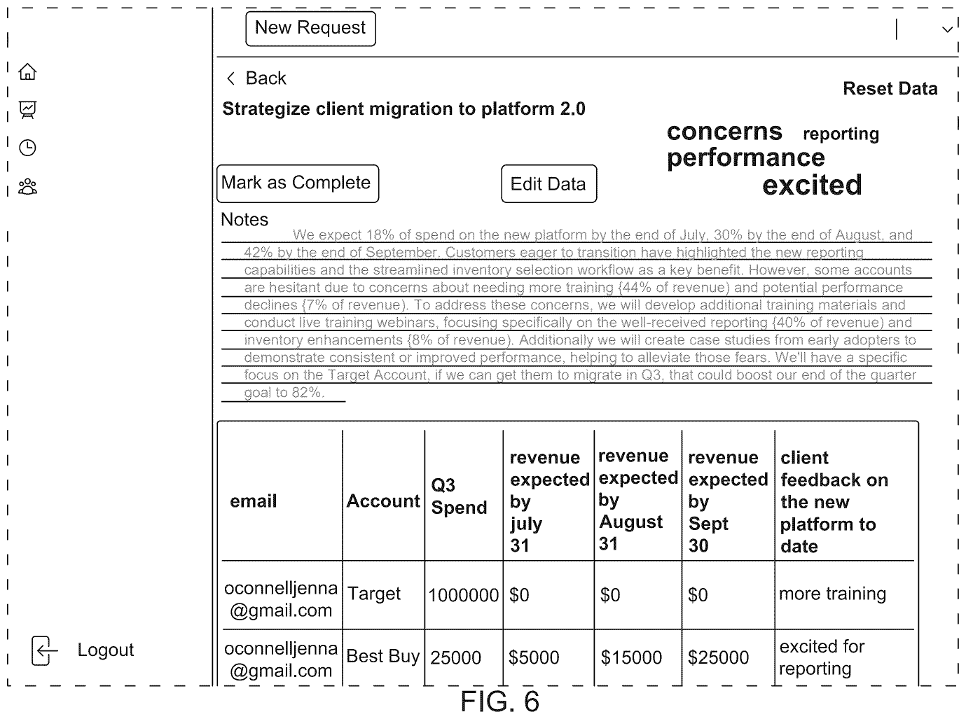

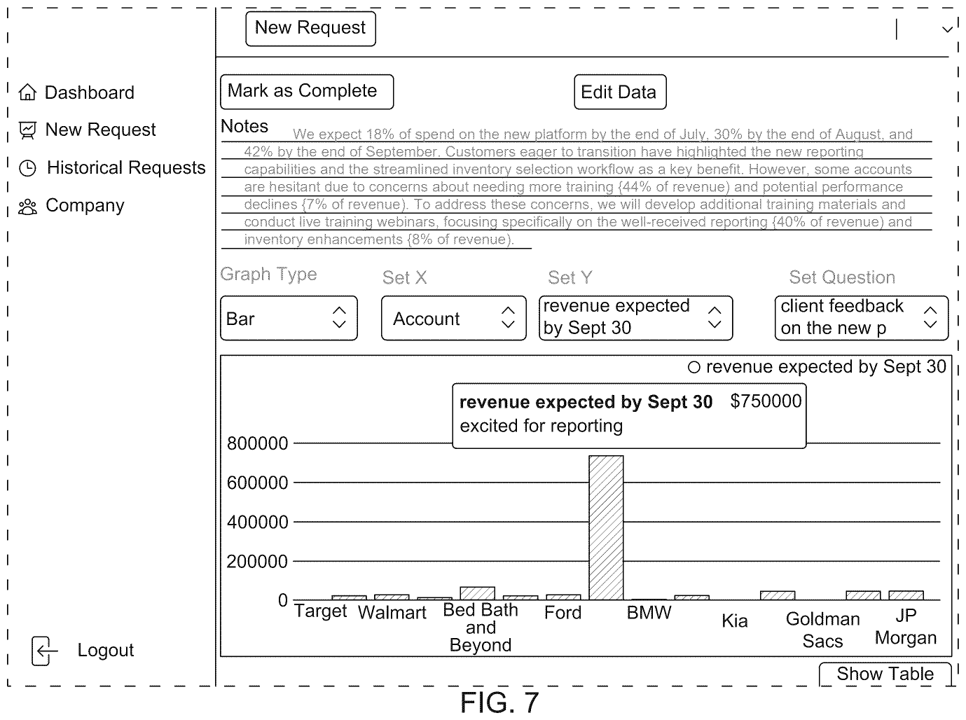

At step 140, one or more summaries can be provided to the user for the new task. In embodiments, the one or more summaries can be visualized on one or more GUI, and can provide one or more informational elements, such as, but not limited to, textual informational element(s), Graph(s), Diagram(s), etc (as illustrated in FIGS. 6-7). Additionally, the one or more summaries through the one or more informational elements, can provide one or more of the one or more metrics, one or more quantitative inputs, one or more qualitative inputs, and/or one or more information items derived therefrom (as illustrated in FIGS. 6-7). Additionally, one or more user interface elements can be provided to filter, sort, or otherwise organize the one or more summaries, one or more informational elements, one or more of the one or more metrics, one or more quantitative inputs, one or more qualitative inputs, and/or one or more information items derived therefrom (as illustrated in FIG. 6-7). In exemplary embodiments, the system can generate one or more analytical interfaces, such as charts, graphs, etc., utilizing one or more of the one or more metrics, one or more quantitative inputs, and/or one or more information items derived therefrom, selected by a user. Additionally, one or more qualitative inputs corresponding to the selected one or more metrics, one or more quantitative inputs, and/or one or more information items derived therefrom, can be overlaid by the system on the corresponding analytical interface.

Finally, at step 145 the one or more informational elements can include one or more Artificial Intelligence (A) Sentiment Clouds generated using one or more of the one or more metrics, one or more quantitative inputs, one or more qualitative inputs, and/or one or more information items derived therefrom, described with respect to FIG. 2.

Referring now to FIG. 2, an AI sentiment cloud method 200 is illustrated. In embodiments, Method 200 can occur in concert with steps 130-140 of FIG. 1. At step 205, one or more users responsible for the one or more requests can act on the one or more requests performing one or more actions, such as responding to the one or more requests, performing one or more actions items, answering a question, etc. In embodiments, the one or more users can perform the one or more actions using one or more user interfaces of the system, which they can use to submit the one or more actions.

At step 210, one or more datasets can be saved to a database of the system, and the system can mark the one or more actions as submitted. In embodiments, the one or more data sets can be data from the one or more files, and/or metrics submitted by the user, and can include one or more qualitative inputs needed by the user corresponding to the one or more datasets. In an exemplary embodiment, the one or more datasets can correspond to user submission in steps 115-120. At step 215, the one or more datasets can be submitted to one or more generative AI system, such as one or more generative pre-trained transformers, or transformer neural networks, for processing.

At step 220, one or more customized prompts can be passed to the generative AI system. In embodiments, the one or more customized prompts can include one or more instructions on a desired response, i.e. what information or sentiments should be pulled from the one or more datasets, how the one or more datasets should be processed, and/or an output requirement. In embodiments, using the generative AI system utilizes the one or more instructions to process the one or more datasets to generate one or more outputs, such as a Sentiment Cloud. In embodiments, the Sentiment Cloud can be a tool configured to visual one or more sentiments, as the one or more outputs, generated by the generative AI system from the one or more datasets. For example, if the one or more datasets include entries “client was unhappy with customer service”, and “client was disappointed with an abundance of software bugs”, the generative AI system can analyze these data points and produce a sentiment as “client frustrations”. In embodiments, the one or more outputs of the generative AI can include data from the one or more datasets, directly, and/or indirectly. In embodiments, the one or more sentiments produced by the generative AI system can be emphasized differently based on importance, frequency, or other attributes as indicated by the one or more prompts, or the one or more instructions, etc. For example, the one or more sentiments can have differing text size, size, color, highlighting, animation, bolding, underline, etc. For example, a sentiment of the one or more sentiments that is more important or appears more frequently can be larger, bolder, etc., than one or more other sentiments.

Finally, at step 225 the one or more outputs can be stored in the database of the system, and/or presented on one or more interface elements to the user (as illustrated in FIG. 6).

Referring now to FIG. 3, a recurrent task analysis method 300 is illustrated. Method 300 can begin at step 305 where the user can mark the at least one new task as recurring. In embodiments, one or more user interface elements can be provided to mark the at least one new task as recurring, such as check boxes, radio buttons, or other UI elements known in the art (as illustrated in FIG. 5). In embodiments, when the at least one new task is marked as recurring an interface element can be provided to allow the user to select a recurrence interval, time period, or other temporal element.

At step 310, one or more initial datasets are uploaded to the system. In embodiments, the one or more initial datasets can include any or all items outlined as data inputs in steps 110-120 above. Stated differently, the one or more datasets can be any, or all of one or more details, one or more files, one or more metrics, one or more quantitative inputs, one or more qualitative inputs, etc., which can be provided as outlined with reference to FIG. 1, above.

At step 315, a first pass processing of the one or more initial datasets can proceed as outlined in steps 115-140 of FIG. 1. At step 330, one or more updated versions of the one or more initial datasets becomes available to one or more users which can be uploaded. At step 335, the one or more users can mark the one or more updated versions as ‘Now’ or current, or the one or more users can match the data with a next update interval, as provided by the user. At step 340, the one or more updated versions can be stored in the database with the one or more initial datasets. Additionally, updates can be made to the one or more initial datasets, and/or the one or more updated versions by the user or the one or more users.

At step 340, one or more tools can be provided to analyze the one or more initial datasets, and/or the one or more updated versions. In embodiments, the user can utilize the one or more tools to analyze the one or more initial datasets, and/or the one or more updated versions.

At step 350, the one or more initial datasets and/or the one or more updated versions can be passed to the generative AI system for processing. In embodiments, the generative AI system can analyze both initial datasets and/or updated versions to determine trends over time, to determine progress, stagnation, and/or failure. In exemplary embodiments, the generative AI system can analyze the one or more metrics, one or more quantitative input, and/or one or more qualitative inputs associated with one or more requests of one or more tasks, to determine progress/stagnation, completion/failure, and/or other trends. In embodiments, the one or more initial datasets and/or the one or more updated versions can be processed, separately, according method 200. Advantageously, trend analysis by the generative AI system is performed over time to aid in data analysis, understanding, and accountability for one or more responsible users. At step 355, one or more outputs of the AI system can be stored to the database and/or output for display as illustrated in FIG. 6-7.

To aid in understanding an exemplary flow is provided, one or more steps may be skipped, or omitted for ease of explanation. A manager wants to understand on a weekly basis how much revenue is at risk across their book of accounts. At step 105-110, the manager can create a new request and add the one or more details of the new request. At 115, The manager can pull a report together including one or more account(s), revenue booked, revenue on track to spend, delta, as a dataset and upload this dataset as a CSV, and/or drag and drop the report to a “Choose File” interface element, as illustrated in FIG. 5. At step 120, The manager can then add qualitative questions to the data set, such as: why is this revenue at risk, how much do we think we can save, what are we going to do to save this revenue? At step 125—, the manager can send the new task including the dataset, and the qualitative questions off to their team to answer those questions about one or more accounts that each team member is responsible for. At step 330—The next week, the manager can run this process again, The responsible team member can see what they said about the account last week, and close the loop accordingly. At step 350—The manager can track if the data is heading in the right direction, i.e. are we reducing the revenue at risk, and if not why not.

It should be understood, of course, that the foregoing relates to exemplary embodiments of the invention and that modifications may be made without departing from the spirit and scope of the invention as set forth in the following claims.

What is claimed is:

1. A computer implemented method for information sharing and situational awareness, the method comprising:
receiving, by a processor, at least one task;
providing, by the processor, one or more metrics associated with the at least one task;
receiving, by the processor, at least one qualitative input item associated with the at least one task or the one or more metrics;
tracking, by the processor, a progress of the at least one task;
analyzing, by the processor, the at least one task to generate at least one dataset;
generating, using the at least one dataset, at least one report including at least one of: a report, a graph, or a sentiment cloud; and
outputting, by the processor, the at least one report to a user interface.

2. The computer implemented method of claim 1, wherein the receiving at least one task, further comprises:
receiving, by the processor, one or more details associated with the at least one task, wherein the one or more details include at least one of: a title, a description, a due date, one or more notes, or a recurrence indicator.

3. The computer implemented method of claim 2, wherein providing one or more metrics associated with the at least one task, further comprises at least one of:
uploading, by the processor, one or more files having the one or more metrics in a standardized format; or
providing, to the processor, the one or more metrics using one or more user interface elements of a user interface, wherein the one or more metrics are one or more quantitative data items.

4. The computer implemented method of claim 1, wherein tracking a progress of the at least one task, further comprises:
receiving, by the processor, at least one user responsible for the at least one task;
tracking, by the processor, one or more actions associated with the at least one task performed by the at least one responsible user;
updating, by the processor, the progress of the at least one task.

5. The computer implemented method of claim 1, wherein generating the sentiment cloud further comprises:
receiving, by one or more generative Artificial Intelligence (AI) systems, the one or more datasets;
receiving, by the one or more generative AI systems, one or more prompts associated with the one or more datasets;
analyzing, by one or more generative AI systems, the one or more datasets using the one or more prompts to determine one or more sentiments;
applying one or more emphasis to the one or more sentiments.

6. A system for information sharing and situational awareness, the method comprising:
at least one processor; and at least one memory storing instructions that when executed by the at least one processor perform a method, the method comprising:
receiving, by the at least one processor, at least one task;
providing, by the at least one processor, one or more metrics associated with the at least one task;
receiving, by the at least one processor, at least one qualitative input item associated with the at least one task or the one or more metrics;
tracking, by the at least one processor, a progress of the at least one task;
analyzing, by the at least one processor, the at least one task to generate at least one dataset;
generating, using the at least one dataset, at least one report including at least one of: a report, a graph, or a sentiment cloud; and
outputting, by the at least one processor, the at least one report to a user interface.

7. The system of claim 6, wherein the receiving at least one task, further comprises:
receiving, by the at least one processor, one or more details associated with the at least one task, wherein the one or more details include at least one of: a title, a description, a due date, one or more notes, or a recurrence indicator.

8. The system of claim 6, wherein providing one or more metrics associated with the at least one task, further comprises at least one of:
uploading, by the at least one processor, one or more files having the one or more metrics in a standardized format; or
providing, to the at least one processor, the one or more metrics using one or more user interface elements of a user interface, wherein the one or more metrics are one or more quantitative data items.

9. The system of claim 6, wherein tracking a progress of the at least one task, further comprises:
receiving, by the at least one processor, at least one user responsible for the at least one task;
tracking, by the at least one processor, one or more actions associated with the at least one task performed by the at least one responsible user;
updating, by the at least one processor, the progress of the at least one task.

10. The system of claim 6, wherein generating the sentiment cloud further comprises:
receiving, by one or more generative Artificial Intelligence (AI) systems, the one or more datasets;
receiving, by the one or more generative AI systems, one or more prompts associated with the one or more datasets;
analyzing, by one or more generative AI systems, the one or more datasets using the one or more prompts to determine one or more sentiments;
applying one or more emphasis to the one or more sentiments.
